(19) United States
(12) Patent Application Publication
(10) Pub. No.: US 2014/0257588 A1
(43) Pub. Date: Sep. 11, 2014

(54) Appliance Shut-Off Device and Method

(71) Applicant: LifeSmart Electronics, LLC, Saltsburg, PA (US)

(72) Inventor: Joseph Michael Matesa, JR., Murrysville, PA (US)

(73) Assignee: LifeSmart Electronics, LLC, Saltsburg, PA (US)

(21) Appl. No.: 14/194,748

(22) Filed: Mar. 2, 2014

Related U.S. Application Data
(60) Provisional application No. 61/773,497, filed on Mar. 6, 2013.

(51) Int. Cl. G06F 1/26; G06F 3/16

(52) U.S. Cl. CPC G06F 1/266; G06F 3/16
USPC 700/297

(57) ABSTRACT

This invention relates to a method and apparatus for reducing damage caused by malfunction of an electrically-powered appliance. The present invention provides a device and method for de-powering electrical equipment upon detection of an alarm signal issued by a separate device (“alarm”). Upon detection of the alarm signal, the microcontroller may de-energize a normally-open relay or other switching device, to interrupt electrical power to an appliance. Smoke detectors are widely available at very low cost, and using the acoustic alarm signal thereof, greatly reduces the cost and complexity of providing a shut-off response in the case of fire, as compared to duplicating the functionality of the smoke detector.

### BACKGROUND OF THE INVENTION

1. Field of the Invention

This invention relates to a method and apparatus for reducing damage caused by malfunction of an electrically-powered appliance.

2. Description of the Prior Art

Many systems have been developed to enhance safety in situations where electrical devices are used. For example, the typical residential circuit breaker senses abnormally large electric currents and interrupts the supply of electrical power under such circumstances.

Another example of a safety system for an electrically-powered device is disclosed in U.S. Pat. No. 6,655,047, which is incorporated herein by reference (“reference 1”). Reference 1 discloses a fire arrester for use with a clothes dryer, which “includes a fire detector at the dryer vent to detect fires starting in the dryer and provides an electrical power disconnect means to break the flow of electrical power being supplied to operate the dryer.” Central to this concept is the installation of a fire detector at the dryer exhaust. Such installation may be inconvenient to carry out on dryers that previously have been put into service, and as such presents a barrier to the widespread acceptance of the disclosed system. Further, the system as described includes the costs of hardware necessary to adapt the fire detector to the dryer vent, as well as the costs and difficulty of installing the extinguishing agent and means of delivery. Using this example as a reference, there is utility in providing a similar type of protection, but with lower costs and less inconvenience.

### SUMMARY OF THE INVENTION

The present invention provides a device and method for de-powering electrical equipment upon detection of an alarm signal issued by a separate device (“alarm”).

In one embodiment, the separate source of the alarm signal is a smoke detector compatible with ISO 8201, the sound of which has pre-defined characteristics. A method of detecting such an alarm is disclosed in U.S. patent application Ser. No. (______), which is incorporated herein by reference (“reference 2”). Upon detection of the alarm signal, the microcontroller may de-energize a normally-open relay or other switching device, to interrupt electrical power to an appliance. ISO 8201-compliant smoke detectors are widely available at very low cost, and using the acoustic alarm signal thereof, greatly reduces the cost and complexity of providing a shut-off response in the case of fire, as compared with duplicating the functionality of the smoke detector.

Another embodiment optionally supplements the detection of a separately-generated alarm signal with local detection of one or more fault conditions. Such local detection may consist of monitoring temperature, vibration, ingress of water, or other parameters that are known to have normal- and abnormal ranges in a given application. The outputs of the alarm-signal detector and the local fault detector are logically combined (e.g., in an “OR” sense) to activate the means of disconnecting electrical power. This feature of the present invention allows the combination of local fault detection in cases where such is practical, with detection of a separately-generated alarm for conditions which are more difficult to detect locally, but for which alarms are commercially available. This feature also provides a measure of redundancy, which enhances the efficacy of the protection as compared to detection of any single fault type.

These and other advantages and features of the present invention will be more fully understood with reference to the presently preferred embodiments thereof and to the appended drawings.

### DESCRIPTION OF THE DRAWINGS

FIG. 1 is a representation of a prior art detection system (reference 1, FIG. 1).

FIG. 2 is a block diagram of one embodiment of the invention.

FIG. 3 is a block diagram of a second embodiment of the invention.

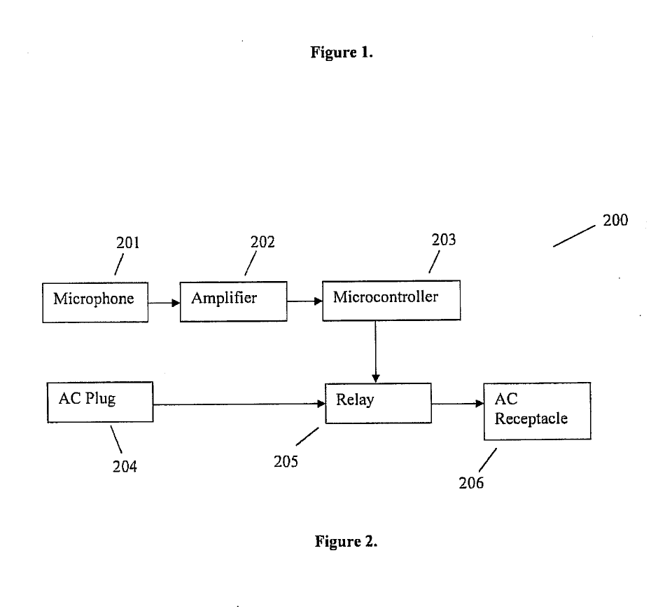

### DESCRIPTION OF THE PREFERRED EMBODIMENTS

Referring now to FIG. 2, a system 200 for de-powering an electrical appliance consists of an AC Plug 204 which connects to a source of utility power, AC Receptacle 206 through which an appliance is powered, and Relay 205 interposed between Plug 204 and Receptacle 206. The operating coil of relay 205 is controlled by a microcontroller 203 of the type commonly used in industry. A microphone 201 is connected to microcontroller 203 by way of an amplifier 202, according to the practice described in reference 2. Microcontroller 203 is programmed to detect the occurrence of the acoustic alarm issued by a standard smoke-detector (not shown), and upon detection of such acoustic alarm, de-activates relay 205. It is preferable for relay 205 to be of the normally-open type, to provide fail-safe operation in the event that microcontroller 203 loses its own source (not shown) of electrical power. Preferably, the aforesaid components of the system 200 are all packaged within a single enclosure, for low cost and ease of installation. Relay 205 may be of the conventional, magnetic-coil type, or a solid-state variety as is well-known in the art.

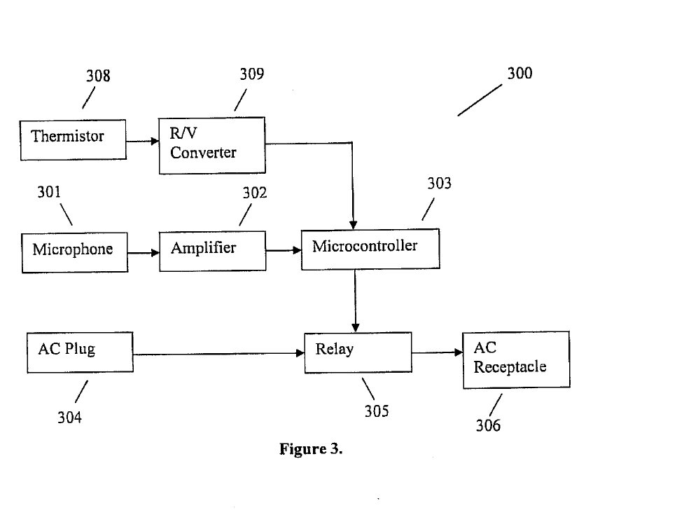

Referring now to FIG. 3, an alternative embodiment system 300 for de-powering an electrical appliance consists of an AC plug 304 which connects to a source of utility power, AC receptacle 306 through which an appliance is powered, and relay 305 interposed between plug 304 and receptacle 306. The operating coil of relay 305 is controlled by microcontroller 303. A microphone 301 is connected to microcontroller 303 by way of an amplifier 302, as described earlier. Microcontroller 303 is programmed to detect the occurrence of the acoustic alarm issued by a standard smoke-detector (not shown), and upon detection of such acoustic alarm, de-activates relay 305. Also connected to microcontroller 303 is a thermistor 308, by way of resistance-to-voltage converter circuit 309. Preferably, thermistor 308 is in thermal contact with an appliance (not shown) that is to be monitored. For example, in the case that system 300 is intended to monitor a clothes dryer, thermistor 308 would preferably be fastened to the exterior surface of the clothes dryer, preferably in a location close to the burner for rapid detection of ignition, and preferably using adhesive tape for convenience of installation. Since any given appliance has a normal operating temperature range, microcontroller 303 is programmed to monitor the resistance of thermistor 308, and if said resistance indicates an excursion of temperature outside of the normal operating range, microcontroller 303 opens relay 305. Preferably, microcontroller 303 responds in this way only to temperature excursions that exceed the detection threshold by a given combination of magnitude and time, in order to minimize the occurrences of false alarms. De-energizing the appliance (not shown) upon detection of a separate alarm (not shown) by way of microphone 301, or upon detection of excessive temperature by way of thermistor 308, provides a measure of redundancy and improves the likelihood of detecting (in this example) a fire.

It will be recognized that reliance on an alarm from a separate fault-detection device (e.g., a smoke detector) results in the possibility of responding to fault conditions un-related to the appliance being powered by way of the system 200 or 300. However, in typical installations of protective devices, the consequences of such “false positive” detections are minimal, while the consequences of failing to respond to a true fault can be much more serious.

Two preferred embodiments of the invention have been described hereinabove and those of ordinary skill in the art will recognize that these embodiments may be modified and altered without departing from the central spirit and scope of the invention. Thus, the embodiments described hereinabove are to be considered in all respects as illustrative and not restrictive. The scope of the invention being indicated by the appended claims rather than the foregoing descriptions and all changes which come within the meaning and range of equivalency of the claims are intended to be embraced herein.

What is claimed is:

1. An appliance shut-off device comprising:
an electrical disconnect;
an alarm detector that controls the disconnect.

2. The appliance shut-off device of claim 1 wherein the alarm detector includes a microphone.

3. The appliance shut-off device of claim 2 wherein the alarm detector incorporates a pattern recognition algorithm that is responsive to the sound of a standard smoke alarm.

4. An appliance shut-off device comprising:
an electrical disconnect;
an alarm detector;
a temperature detector;
a logic element that combines the outputs of the alarm detector and temperature detector to control the disconnect.

5. The appliance shut-off device of claim 4 wherein the alarm detector includes a microphone.

6. The appliance shut-off device of claim 5 wherein the alarm detector incorporates a pattern recognition algorithm that is responsive to the sound of a standard smoke alarm.

7. The appliance shut-off device of claim 5 wherein the temperature detector is a thermistor.

8. A method for de-powering an appliance comprising:
detection of an acoustic signal from a separate alarm;
interrupting the electrical power supply path to the appliance.

9. The method of claim 8 wherein the detection algorithm responds primarily to the sound of a standard smoke alarm.

10. The method of claim 9 wherein the detection algorithm responds to a repetitive signal pattern.

11. The method of claim 10 wherein the detection algorithm requires two or more instances of the repetitive signal pattern in order to indicate positive detection.

12. A method for de-powering an appliance comprising:
detection of an acoustic signal from a separate alarm;
detection of surface temperature of the appliance;
combining the results of the aforesaid detection operations to form a logical aggregate signal;
interrupting the electrical power supply path to the appliance in response to the logical aggregate signal.

13. The method of claim 12 wherein the detection algorithm responds primarily to the sound of a standard smoke alarm.

14. The method of claim 13 wherein the detection algorithm responds to a repetitive signal pattern.

15. The method of claim 14 wherein the detection algorithm requires two or more instances of the repetitive signal pattern in order to indicate positive detection.
